(19) United States
(12) Patent Application Publication
(10) Pub. No.: US 2026/0161475 A1
(43) Pub. Date: Jun. 11, 2026

(54) COARSE-GRAINED MULTITHREADING OF PROCESSING CORES

(71) Applicant: QUALCOMM Incorporated, San Diego, CA (US)

(72) Inventors: Vinay PATEL, Stouffville (CA); Luca MARONCELLI, Austin, TX (US); Yiran HUANG, Cambridge (GB); Gayathri VAIDHYANATHAN, San Jose, CA (US)

(21) Appl. No.: 18/975,892

(22) Filed: Dec. 10, 2024

(51) Int. Cl. G06F 9/50; G06F 21/44

(52) U.S. Cl. CPC G06F 9/5055; G06F 21/44

(57) ABSTRACT

Certain aspects of the present disclosure provide a method for managing access to shared execution resources. The method includes receiving requests from multiple processing cores for access to same execution resources. The method further includes granting access to the execution resources to different processing cores according to a time multiplexed scheme, in which each processing core is granted access to the execution resources for a different time slot.

### BACKGROUND

### Field of the Disclosure

Aspects of the present disclosure relate to techniques for managing multithreading of processing cores.

### Description of Related Art

A central processing unit (CPU) is a primary component of a computer that performs most of processing inside. The CPU is often referred to as a brain of the computer because the CPU handles execution of instructions from programs, processes data, and controls other parts of the computer.

CPUs come in various designs and architectures, with different numbers of processing cores, clock speeds, and other features, which all affect performance.

A processing core is a component of the CPU that is capable of executing instructions independently. For example, the processing core is a single processing unit within the CPU that can execute its own thread of instructions. The CPU may include multiple processing cores, which allows the processing cores to execute multiple tasks concurrently or in parallel, significantly improving performance for multi-threaded applications or multi-tasking environments.

Multithreading is a technique in computing that allows a program or process to execute multiple threads concurrently. A thread may be a smallest unit of execution within a process, and the multithreading enables a program to perform several tasks at a same time, improving its efficiency, responsiveness, and overall performance. This can be particularly useful in systems with multi-core processors or in situations where the program needs to handle multiple independent tasks concurrently.

Coarse-grained multithreading is a type of the multithreading in which multiple threads (e.g., tasks) are executed in parallel, but switching between the threads occurs at a relatively large scale or infrequently. In the coarse-grained multithreading, when one thread is waiting for some event (such as input/output completion or a cache miss), the processing core switches to another thread, continuing its execution. However, the thread switch occurs after a significant amount of time or at specific intervals. This contrasts with fine-grained multithreading, where the processing core switches between the threads more frequently, often every clock cycle, to maximize throughput and utilization of the CPU resources.

When an operating system switches from executing one process or thread to another (e.g., for multitasking), it saves a context of a current process or thread (i.e., values in registers, program counter, etc.) and restores the context of the new process or thread. This allows a system to switch between tasks efficiently while maintaining a state of each task, so when it resumes, it can continue from exactly where it left off.

A context of the processing core may refer to a complete set of information that defines a current state of the processing core and its execution at a given point in time. This includes all data that the processing core needs in order to resume or continue processing after a context switch (e.g., when the operating system switches the processing core focus from one task to another).

Context switching is a mechanism in operating systems that allows for multitasking. It involves saving and restoring a state of the processing core when switching between the tasks. This process is essential for efficient CPU resource management, supporting multitasking, handling interrupts, and enabling responsiveness.

### SUMMARY

One aspect provides a method for managing access to shared execution resources, including: receiving requests, from a plurality of processing cores, for access to same execution resources for execution of corresponding instruction streams; and granting access to the execution resources to different processing cores of the plurality of processing cores according to a time multiplexed scheme, in which each processing core is granted access to the execution resources for a different time slot.

Other aspects provide: an apparatus operable, configured, or otherwise adapted to perform the aforementioned method as well as those described elsewhere herein; a non-transitory, computer-readable media comprising instructions that, when executed by one or more processors of an apparatus, cause the apparatus to perform the aforementioned method as well as those described elsewhere herein; a computer program product embodied on a computer-readable storage medium comprising code for performing the aforementioned method as well as those described elsewhere herein; and an apparatus comprising means for performing the aforementioned method as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system-on-chip (SoC), in accordance with certain aspects of the present disclosure.

FIG. 2 depicts example communication between processing cores and a resource manager including execution resources, in accordance with certain aspects of the present disclosure.

FIG. 3 depicts example cases of a scheme for a single processing core in a streaming mode and for a cluster of four processing cores in the streaming mode, in accordance with certain aspects of the present disclosure.

FIG. 4 depicts example cases of a coarse-grained multithreading scheme for a single processing core in a streaming mode and for a cluster of four processing cores in the streaming mode, in accordance with certain aspects of the present disclosure.

FIG. 5A depicts a flow diagram for managing granting of access to execution resources to a processing core, in accordance with certain aspects of the present disclosure.

FIG. 5B depicts a flow diagram for managing granting of access to execution resources to a previously inactive processing core, in accordance with certain aspects of the present disclosure.

FIG. 5C depicts a flow diagram for managing granting of access to execution resources to a previously active processing core, in accordance with certain aspects of the present disclosure.

FIG. 6 depicts a method for managing access of shared execution resources to different processing cores, in accordance with certain aspects of the present disclosure.

### DETAILED DESCRIPTION

A central processing unit (CPU) system may include multiple processing cores for enabling concurrent execution of multiple programs or threads. The processing cores may send their instructions to a resource manager at a same time for execution. The resource manager may have sufficient resources and may support all the processing cores at the same time. The resources associated with the resource manager may include storage arrays or elements (e.g., for matrix operations), caches etc.

The simultaneous support for the multiple processing cores may require the resource manager to include or have multiple modules and ports (e.g., storage arrays) associated with the multiple processing cores. This may require a large storage area at the resource manager to accommodate the multiple modules and ports corresponding to the multiple processing cores.

To avoid having the large storage area, the resource manager may support a multi-threaded approach where the multiple processing cores may arbitrate for and share resources associated with the resource manager. For example, based on the multi-threaded approach, at any given time, only a single processing core may have access to the resources associated with the resource manager. Accordingly, the resource manager has to accommodate the modules and ports corresponding to only a single processing core, which may require less storage area at the resource manager.

Techniques proposed herein describe various arbitration scenarios between the multiple processing cores and the resource manager for access to same (common/shared) execution resources associated with the resource manager in a time multiplexed manner based on an arbitration window that spans several thousand cycles. An arbitration between the multiple processing cores and the resource manager for access to the same execution resources associated with the resource manager may be based on a request and grant handshake that may be used between the processing cores and the resource manager to negotiate access to the same execution resources associated with the resource manager.

In some aspects, based on the arbitration between the multiple processing cores and the resource manager, a first processing core may dispatch a workload on the resource manager that runs until its timeslot (e.g., for access to the execution resources associated with the resource manager) expires. A second processing core may raise its request for access to the resources associated with the resource manager before the first processing core's timeslot expires. Thus, the second processing core may have to wait for a next timeslot, after which the second processing core may start its workload on the resource manager for a certain timeslot. Once the second processing core timeslot expires, then first processing core may continue and complete its workload on the resource manager. A new arbitration between the multiple processing cores and the resource manager may be started once the first processing core lowers its request for access to the resources associated with the resource manager.

In some aspects, when any processing core loses its grant of the resources associated with the resource manager as its timeslot expires, the processing core may send an end of stream (EOS) message to the resource manager. The resource manager may consider the EOS message as a final packet from the processing core losing the grant of the resources associated with the resource manager and inserts its context save sequence after this point. A context switching sequence between a retiring processing core and an initializing processing core may then be fully serialized. That is, a context save sequence may be fully inserted for the retiring processing core before a context restore sequence for a next processing core. For example, a state of a currently executing processing core is stored away and a state of the processing core being switched in is retrieved from a memory.

The context save sequence and the context restore sequence may refer to a process of saving and restoring a state (or “context”) of the processor core when switching between different tasks (e.g., threads or processes). The context save sequence and the context restore sequence may enable the processor core to handle multiple tasks concurrently or in quick succession by switching from one executing task to another, effectively giving the illusion of parallel execution on systems with limited processing resources.

In some aspects, one of the processing cores may raise a priority signal to indicate a low-latency switch is required. Instead of waiting for a counter expiration, the resource manager may make its best effort to switch out a low priority thread for a requestor processing core as soon as possible.

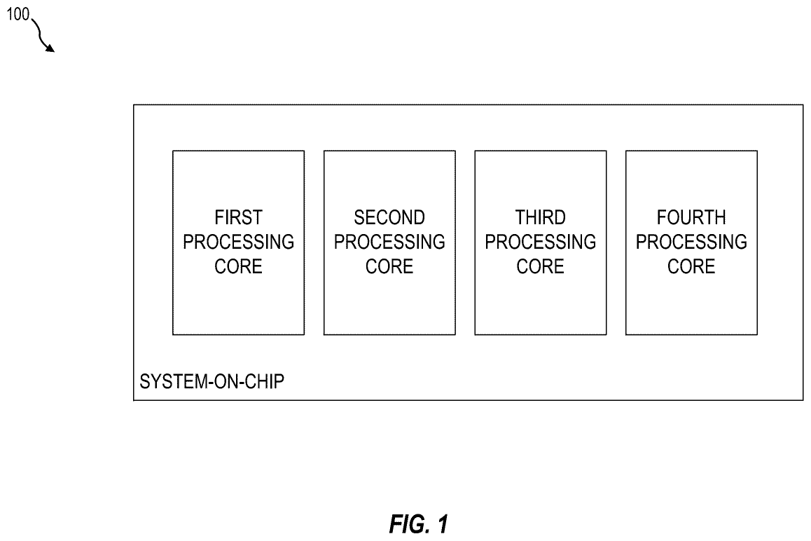

The techniques proposed herein for managing access to shared execution resources may be further understood with reference to FIG. 1-FIG. 6.

### Example System-On-Chip (SoC)

FIG. 1 depicts an example system-on-chip (SoC) 100 with multiple processing cores (e.g., on which artificial intelligence workloads may be processed).

The multiple processing cores may include a first processing core, a second processing core, a third processing core, and a fourth processing core. The first processing core, the second processing core, the third processing core, and the fourth processing core may include at least efficiency cores and performance cores.

The SoC 100 may further include a graphics processing unit (GPU) and a neural processing unit (NPU), amongst other processing units and components on which various compute workloads may be processed (e.g., tensor processing units, application-specific integrated circuits (ASICs), digital signal processors (DSPs), and the like).

The efficiency cores and the performance cores may be processing units implementing a same processing architecture (e.g., processing units implementing advanced reduced instruction set computer (RISC) machines (ARM) or RISC-V architectures). The efficiency cores may have a lower performance (e.g., as measured by a number of operations per second that the efficiency cores can perform) than the performance cores, but may use less power than the performance cores in executing a workload.

The GPU may be a processing unit which is configured to perform large mathematical operations (e.g., matrix, vector, tensor, etc. operations) in parallel.

The NPU is a circuit configured for implementing control and arithmetic logic for executing machine learning algorithms, such as algorithms for processing artificial neural networks (ANNs), deep neural networks (DNNs), random forests (RFs), and the like. The NPU may be referred to as a neural signal processor (NSP), a tensor processing unit (TPU), a neural network processor (NNP), an intelligence processing unit (IPU), a vision processing unit (VPU), or a graph processing unit.

The NPU may be configured to accelerate performance of common machine learning tasks, such as image classification, machine translation, object detection, and various other predictive artificial intelligence models. In some examples, a plurality of NPUs may be instantiated on a single chip while in other examples such NPUs may be part of a dedicated neural-network accelerator.

The NPU may be optimized for training or inference, or in some cases configured to balance performance between both. For the NPU that is capable of performing both training and inference, two tasks may still be performed independently.

The NPU designed to accelerate training may be configured to accelerate an optimization of new artificial intelligence models, which is a highly compute-intensive operation that involves inputting an existing dataset (often labeled or tagged), iterating over a dataset, and then adjusting artificial intelligence model parameters, such as weights and biases, in order to improve artificial intelligence model performance. Generally, optimizing based on a wrong prediction involves propagating back through layers of an artificial intelligence model and determining gradients to reduce a prediction error.

The NPU designed to accelerate inference may be configured to operate on complete artificial intelligence models. The NPU may thus be configured to input a new piece of data and rapidly process this new piece through an already trained artificial intelligence model to generate an artificial intelligence model output (e.g., an inference).

Each of the processing units on the SoC 100 (e.g., the efficiency cores, the performance cores, the GPU, the NPU, and/or other processing units) may have different performance characteristics. The performance characteristics may include a power slope, a leakage power, a dynamic clock and voltage scaling points (e.g., points at which processing core clock speed and voltage draw scales upward or downward), instructions-per-clock cycle (IPC) performance levels, and the like.

The workloads executing on the SoC 100 may be defined by various characteristics which may influence how these workloads, or portions thereof, are scheduled for execution on various processing units of the SoC 100. For example, the workloads may be characterized by a number of stages (e.g., layers) in an artificial intelligence model executing on the SoC 100, a length of an input into the artificial intelligence model, data types associated with each stage or layer of the artificial intelligence model.

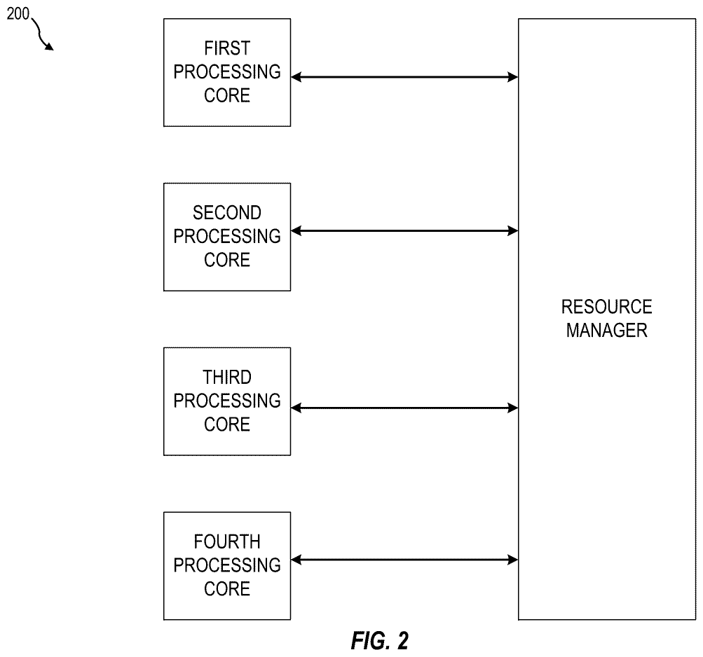

FIG. 2 depicts a diagram 200 illustrating multiple processing cores (e.g., as depicted in FIG. 1) and a resource manager. The multiple processing cores may include a first processing core, a second processing core, a third processing core, and a fourth processing core. The multiple processing cores may have access to shared or same execution resources associated with the resource manager to process their respective workloads.

### Example Supervisor Mode Execution (SME) States

In computing, SME states refer to supervisor mode execution (SME) states, a concept used in computer architecture, particularly in a context of operating systems and processor design.

The SME states may be used to distinguish between different privilege levels or operational states in a processor. The SME states may be part of the processor's control mechanisms that manage how code is executed and what resources are accessible at a given privilege level.

In the context of processor architecture and execution modes, a supervisor mode (SM) field may refer to a flag or control field that determines or indicates whether the processor is operating in the SM.

The SME extends a processor state (PSTATE) register with SM and ZA fields. Z indicates a variable name (x, y, z) and A indicates an array (e.g., a storage array) for matrix operations. The PSTATE register may be a key control register in processor architectures, used to store and manage critical processor state information. The PSTATE register tracks current operating conditions, execution state, and status flags of the processor.

PSTATE fields may control the SME execution and may be modified by secure monitor smart (SMSTART) and secure monitor stop (SMSTOP) instructions, and reading and writing a scalable vector control register (SVCR) register. The SVCR register may be a system register used in processor architectures, for controlling behavior of a scalable vector extension (SVE). The SVE is an extension to the processor architecture that enhances vector processing capabilities, primarily for high-performance computing, machine learning, and data processing.

The SME state may enable and disable different sub-units in a resource manager. The SME state may have an impact on power usage of the resource manager.

### Example Resource Manager And Multithreading Schemes

A resource manager may be a shared resource in a Nuvia Cpu Cluster (NCC). The resource manager may be accessed by any processing core in a cluster of processing cores by either entering a streaming mode or enabling ZA access through a secure monitor smart (SMSTART) instruction. Z indicates a variable name (x, y, z) and A indicates an array (e.g., a storage array) for matrix operations. This mechanism may be supported by advanced reduced instruction set computer (RISC) machines (ARM) instruction set architecture (ISA) and allows a sharing scheme to be fully handled in a hardware without any software intervention.

The resource manager may implement a streaming scalable vector extension (SVE) mode scheme where instructions or instruction streams from different processing cores may be interleaved on a fine granule and execute the instructions concurrently. This is a relatively straight forward approach as it doesn't require a blocking arbitration between the resource manager and the processing cores. The streaming SVE mode may support execution of a subset of SVE2 instructions with SME defined vector length known as streaming SVE vector length (SVL).

The resource manager may not implement per-processing core resource partitioning. Since the resource manager may not implement the per-processing core resource partitioning, an overall resource manager instructions per cycle (IPC) may not increase if the multiple processing cores stream instructions concurrently. For example, the expectation may be that a single processing core executing alone may max out the resource manager IPC, and if N number of processing cores execute concurrently each processing core may have an IPC of (a single processing core IPC/N number).

The IPC may be a performance metric used to measure how efficiently the processor core executes instructions. The IPC represents an average number of instructions the processor core completes per clock cycle. The IPC may be a critical indicator of the processor core efficiency and is influenced by both hardware architecture and software being executed.

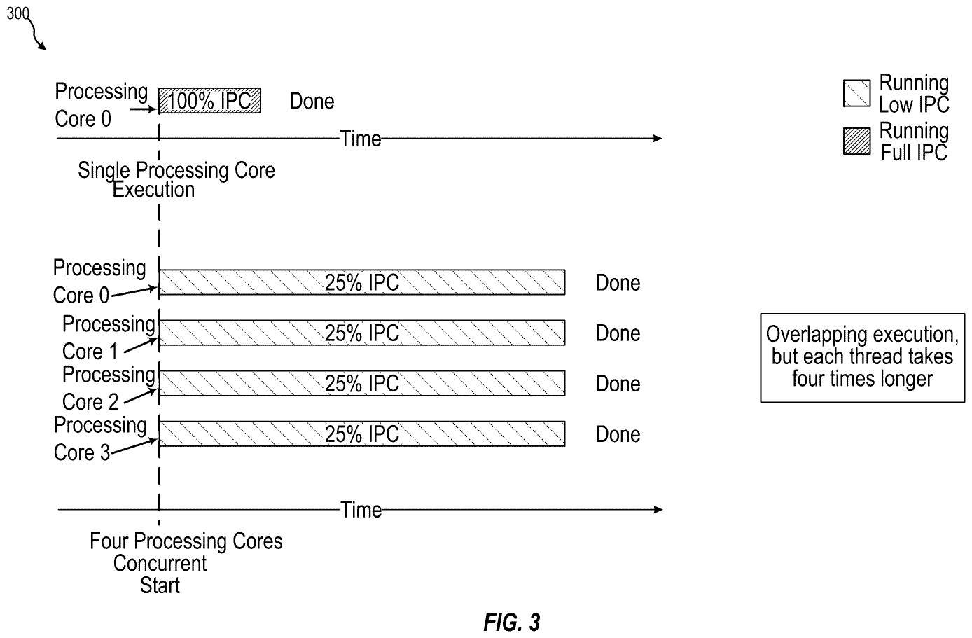

FIG. 3 depicts a diagram 300 showing example cases of a scheme for a single processing core in a streaming mode and for a cluster of four processing cores in the streaming mode. The four processing cores may include a first processing core (e.g., core 0), a second processing core (e.g., core 1), a third processing core (e.g., core 2), and a fourth processing core (e.g., core 3).

In one case, only the first processing core may send its traffic to a resource manager for execution, and the resource manager may provide resources to support the first processing core. In this case, there is 100% IPC for the first processing core.

In another case, the four processing cores may send their traffic to the resource manager at a same time for execution, and the resource manager may have sufficient resources to support all the four processing cores at the same time. However, in this case, the IPC may be evenly divided between all the four processing cores that are running on the resource manager (i.e., 25% IPC for each processing core).

This scheme may require the resource manager to hold multiple copies of SME state and all SME state copies may have to be readily accessible from its execution units. The SME state may include a rename table, ZA array, etc. A number of the SME state copies may have to be the same as a number of the processing cores that may execute concurrently. So, higher the number of processing cores, higher the number of SME state copies that may have to be managed by the resource manager. One drawback of holding the multiple SME state copies is low area and power efficiency of the resource manager. For example, the ZA array may be a multi-port structure and having multiple ZA arrays corresponding to the multiple processing cores may require a higher number of ports (i.e., more area usage at the resource manager for the ports).

To avoid some of the drawbacks of per-processing core SME state replication, the resource manager may implement a coarse-grained multithreading scheme. For example, instead of overlapping execution of instructions from the multiple processing cores, instruction streams from different processing cores may be time multiplexed based on an arbitration window that may span several thousand cycles. At an end of each cycle or a time window allocated for a processing core, a state of a currently executing processing core may be stored and a state of a processing core being switched in may be retrieved from a memory.

As per the coarse-grained multithreading scheme, execution resources associated with the resource manager may not be statically partitioned, so an average IPC that each processing core experiences is an overall maximum IPC of the resource manager divided by a number of processing cores that are in streaming mode concurrently.

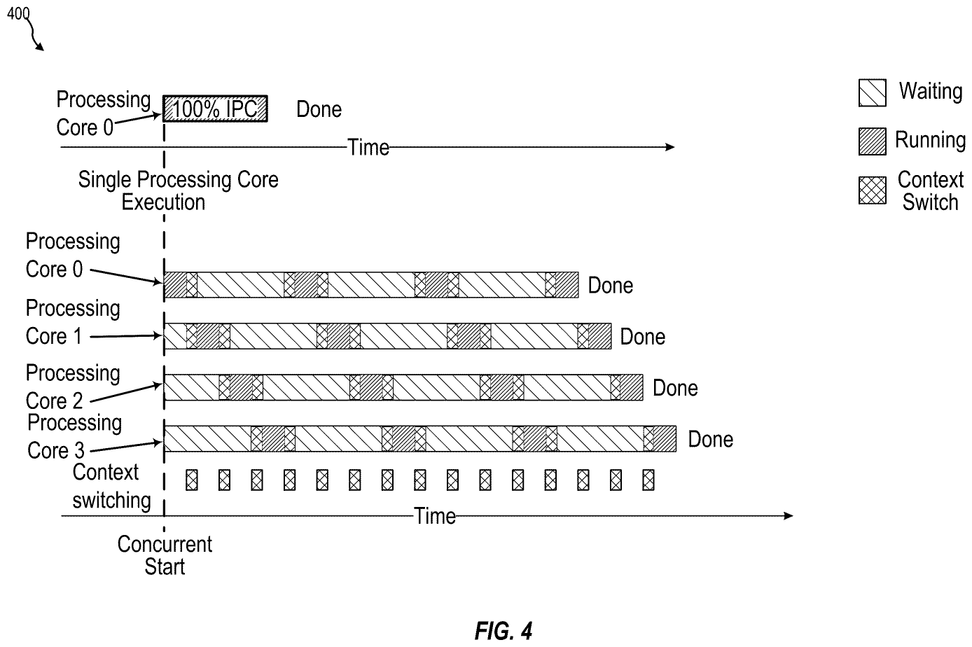

FIG. 4 depicts a diagram 400 showing example cases of a coarse-grained multithreading scheme for a single processing core in a streaming mode and for a cluster of four processing cores in the streaming mode. The four processing cores may include a first processing core (e.g., core 0), a second processing core (e.g., core 1), a third processing core (e.g., core 2), and a fourth processing core (e.g., core 3).

In one case, only the first processing core may send its traffic to a resource manager for execution, and the resource manager may provide resources to support the first processing core. In this case, there is 100% IPC for the first processing core.

In another case, each of the four processing cores may send its traffic to the resource manager in a time multiplexed mode (e.g., which may be based on an arbitration window). For example, at an end of each cycle, a state of a currently executing processing core (e.g., the first processing core) is stored and a state of another processing core (e.g., the second processing core) being switched in is retrieved from a memory.

The processing core state switching may incur a cost in terms of a time overhead (e.g., of approximately 2-300 cycles). The effect of this time overhead may be mitigated by increasing an execution/arbitration window.

The processing core state switching may lead to increased interrupt latency. For example, when a certain processing core is waiting for its execution window, the processing core may not be able to send any instructions to the resource manager, so any operating system or hypervisor handlers trying to switch out (or migrate) a task may not be able to do so until the resource manager may re-arbitrate the processing core.

### Example Techniques for Managing Access of Shared Execution Resources to Different Processing Cores

Techniques proposed herein describe various arbitration scenarios between multiple processing cores for access to same execution resources.

For example, a single thread may be switched between the multiple processing cores. If multiple threads are available, then a processing core not losing arbitration for access to the execution resources may be unaffected and sequences may be unchanged. All arbitration and context switching corresponding to the multiple processing cores may be handled serially. That is, any subsequent arbitration trigger by the processing core may be queued until an ongoing context switch corresponding to another processing core completes or finishes.

In computing, a thread may be a smallest unit of execution within a process. The thread may be a sequence of instructions that can be scheduled and executed by the processing core. Multiple threads may run concurrently in the process, enabling parallelism and more efficient use of system resources. A technique of using the multiple threads within the process is called multithreading. The multithreading may be used to improve efficiency and responsiveness of applications by allowing them to perform multiple tasks concurrently.

The context switching may refer to a process of saving and restoring a state (or “context”) of the processor core when switching between different tasks (e.g., threads or processes). The context switching enables the processor core to handle multiple tasks concurrently or in quick succession by switching from one executing task to another, effectively giving the illusion of parallel execution on systems with limited processing resources. The context switching is a critical component in multitasking and multi-threading systems. For example, when an operating system or a scheduler decides to pause the execution of one task (e.g., a thread or process) and switch to another, the context switch process involves saving the current state of the task being paused (its registers, program counter, etc.), and loading the saved state of the next task to be executed.

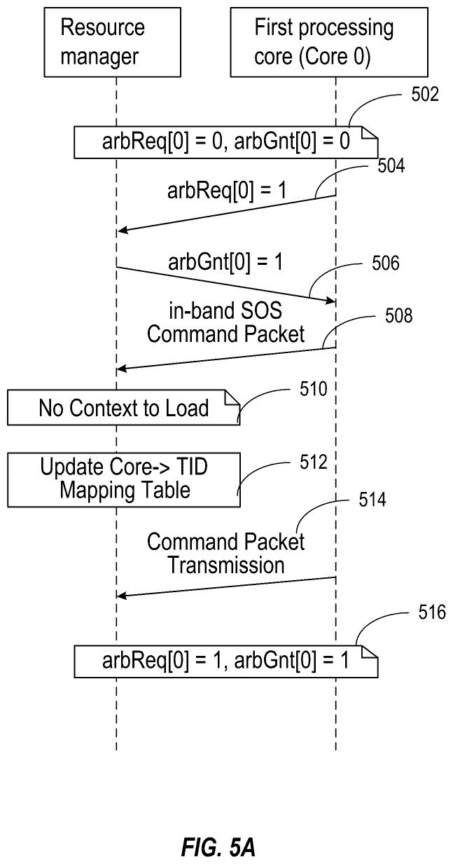

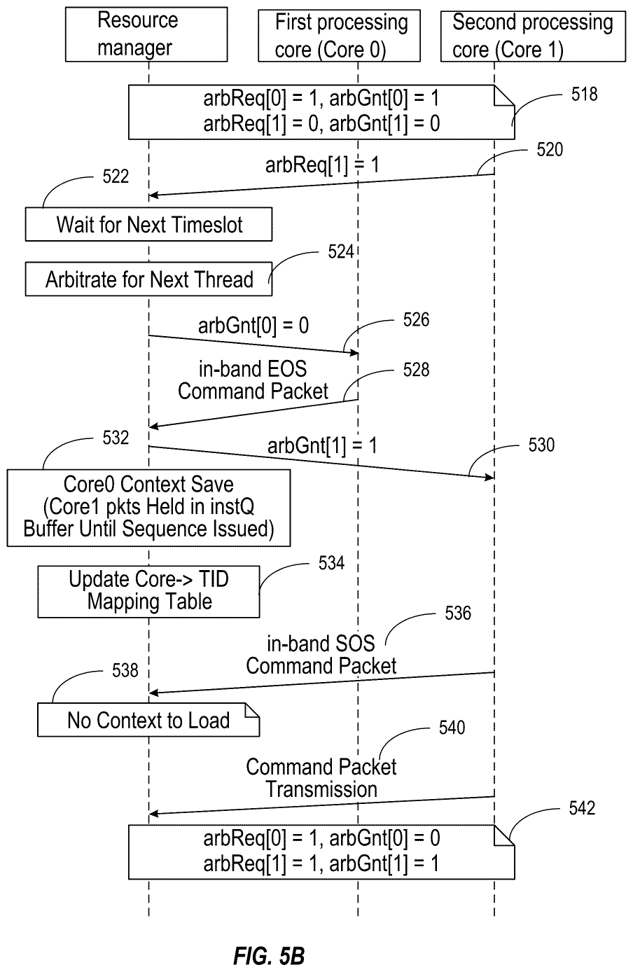

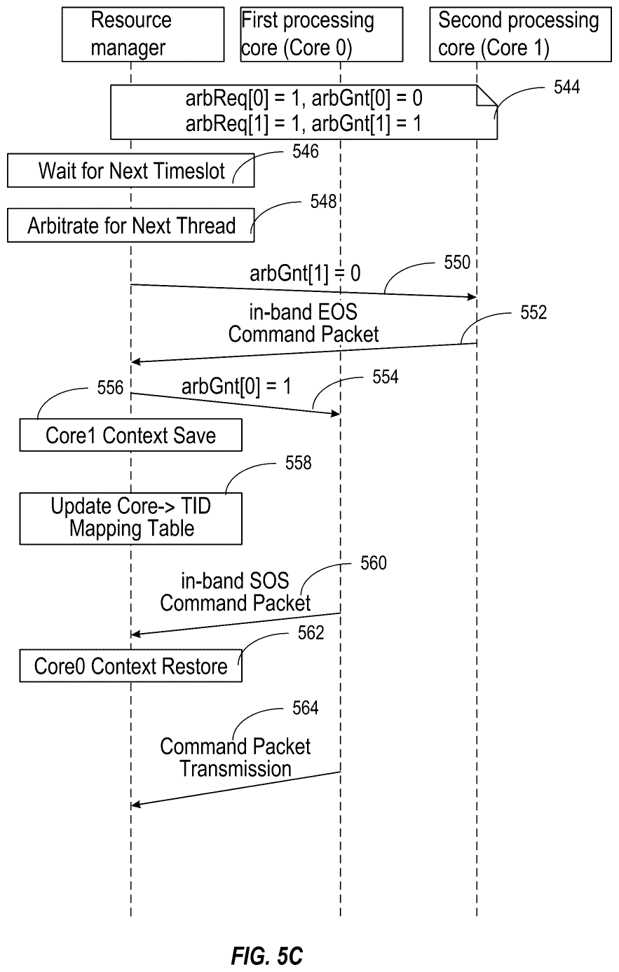

FIG. 5A depicts a flow diagram for managing granting of access to execution resources to a first processing core (e.g., core 0).

At 502, a resource manager is in an idle state. For example, during the idle state of the resource manager, execution resources associated with (or managed by) the resource manager have not been granted to any processing core and are available for allocation to one or more processing cores.

The first processing core is in an idle state. This means that the first processing core is not running and may not have sent any request to the resource manager for access to the execution resources (e.g., for execution of its workload). For example, during the idle state of the first processing core, arbReq[0]=0 (e.g., which means that no arbitration request for the execution resources has been sent to the resource manager by the first processing core) and arbGnt[0]=0 (e.g., which means that the execution resources are not granted to the first processing core by the resource manager).

At 504, the first processing core becomes active and may require the execution resources. The first processing core sends a request (e.g., such as an arbitration request) for access to the execution resources for execution of its workload to the resource manager. For example, arbReq[0]=1 (e.g., which means that the request for the execution resources from the first processing core is sent to the resource manager).

At 506, the resource manager receives the request from the first processing core. The resource manager may immediately send an indication to grant access to the execution resources to the first processing core for a certain time slot, in response to the received request, since the resource manager is in the idle state. For example, arbGnt[0]=1 (e.g., which means that the execution resources are granted to the first processing core by the resource manager). In this context, a timeslot refers to a specific, predefined period of time in which a task or process is allowed to execute.

At 508, the first processing core sends an in-band start of stream (SOS) command packet to the resource manager. The in-band SOS command packet may be a starting indicator, which may indicate a beginning of a command packet transmission (e.g., workload or instructions) from the first processing core to the resource manager.

In some implementations, the in-band SOS command packet may also indicate whether or when to switch any context associated with the first processing core stored in a memory (e.g., any previously stored context of the first processing core) into an active region. For example, the in-band SOS command packet may indicate that there is no context associated with the first processing core to be loaded (e.g., since there was no previous activity of the first processing core at the resource manager).

The context of the first processing core may refer to a complete set of information that defines a state of the first processing core when the first processing core is executing a specific thread or process. This information is crucial for the first processing core to correctly resume execution after an interruption, context switch, or when the first processing core switches between different tasks. The context includes all architectural state and control information that the first processing core may need to manage execution, maintain program continuity, and ensure proper operation.

At 510, the resource manager determines that there is no context associated with the first processing core to be loaded (e.g., which may be determined based on the in-band SOS command packet). For example, the resource manager may determine that the request from the first processing core is a first request from the first processing core and there is no previous activity of the first processing core corresponding to the resource manager. This may suggest there that there is no previously stored context of the first processing core that has to be restored.

At 512, the resource manager updates a table storing information associated with different processing cores and their contexts. For example, the table may show which processing core is associated with which context and its associated context identification (ID). In one aspect, multiple processing cores may be associated a same context ID. In another aspect, the multiple processing cores may be associated with different contexts IDs.

The resource manager may update context information associated with the first processing core in the table. For example, the resource manager may update the table to indicate there is no context available for the first processing core.

At 514, the first processing core sends the command packet transmission (e.g., which may be associated with its workload) to the resource manager. For example, the first processing core may process the workload based on the execution resources are granted to the first processing core.

In some aspects, a command packet arriving from the first processing core may include a header and a variable number of instructions as each instruction may have a variable size payload depending on its type. 3-6 instructions may be packed into a 64-byte packet.

In some aspects, the first processing core creates a packed command packet. Each instruction may be packed with a varying number of payloads, determined by supporting data required to process that instruction. The header may be created to facilitate decoding of the command packet. The header may include information for up to 8 packed instructions.

At 516, the first processing core is in a busy state. For example, the first processing core may have access to the execution resources and processes the workload based on the execution resources. For example, during the busy state of the first processing core, arbReq[0]=1 and arbGnt[0]=1.

FIG. 5B depicts a flow diagram for managing granting of access to the execution resources to a previously inactive processing core.

The example assumes the resource manager is initially in a busy state (i.e., the execution resources associated with the resource manager are granted to the first processing core).

As illustrated at 518, the illustrated example assumes the first processing core is in the busy state (i.e., already running) and have access to the execution resources. For example, arbReq[0]=1 and arbGnt[0]=1.

A second processing core (e.g., core 1) is in an idle state. This means that the second processing core is not running and may not have sent any request to the resource manager for access to the execution resources (e.g., for execution of its workload). For example, during the idle state of the second processing core, arbReq[1]=0 (e.g., which means that no arbitration request for the execution resources has been sent to the resource manager by the second processing core) and arbGnt[1]=0 (e.g., which means that the execution resources are not granted to the second processing core by the resource manager).

At 520, the second processing core becomes active and may require the execution resources. The second processing core sends a request (e.g., an arbitration request) for access to the execution resources for execution of its workload to the resource manager. For example, arbReq[1]=1 (e.g., which means that the request from the second processing core is sent to the resource manager).

The second processing core may send this request to the resource manager at a time or during the timeslot when the execution resources associated with the resource manager are allocated to the first processing core by the resource manager.

At 522, the resource manager waits for a next or a subsequent timeslot to process the request from the second processing core. For example, the resource manager may wait until time allocated for the first processing core for access to the execution resources is finished to process the request from the second processing core.

At 524, the resource manager arbitrates for a next thread, after the time allocated to the first processing core for access to the execution resources is finished. For example, the resource manager may determine that the first processing core has lost access to the execution resources, after the time allocated for the first processing core for access to the execution resources is finished.

At 526, the resource manager sends an indication to the first processing core that the first processing core has lost access to the execution resources (e.g., after the first processing core time window for access to the execution resources has elapsed, the first processing core loses the grant to the execution resource). For example, the indication may indicate that arbGnt[0]=0 (e.g., which means that the execution resources are not granted to the first processing core).

At 528, the first processing core sends an in-band end of stream (EOS) command packet to the resource manager. The in-band EOS command packet may be an ending indicator, which may indicate an end of the command packet transmission from the first processing core to the resource manager. For example, the first processing core may determine to stop sending data and/or traffic to the resource manager and may send the in-band EOS command packet to the resource manager, once its time window for access to the execution resources has elapsed.

In some aspects, the first processing core may also send another request (or may update its previously sent request) to the resource manager for further access to the execution resources (e.g., arbReq[0]=1). For example, the first processing core may leave its request for access to the execution resources high if the first processing core may have more data and instructions to process/send. The resource manager may receive this new request for access to the execution resources from the first processing core, after previously receiving the request for access to the same execution resources from the second processing core. So, the resource manager may determine to first process the request from the second processing core.

At 530, the resource manager sends an indication to grant access to the execution resources to the second processing core for a certain time slot, in response to the received request from the second processing core. For example, arbGnt[1]=1 (e.g., which means that the execution resources are granted to the second processing core).

The resource manager may grant access to the execution resources to the second processing core only after the resource manager receives the in-band EOS command packet from the first processing core.

At 532, the resource manager stores a current context of the first processing core (e.g., after the first processing core time window for access to the execution resources has elapsed) in a memory associated with the resource manager.

After receiving the grant for the access to the execution resources, the second processing core may start sending packets and instructions to the resource manager, however, the packets and instructions may be provisionally held in an instructions (instQ) buffer associated with the resource manager. For example, the resource manager may store the packets and instructions associated with the second processing core in the instQ buffer until a sequence may be issued.

At 534, the resource manager updates the table storing the information associated with the different processing cores. For example, the resource manager may store the context associated with the first processing core in the table. This may allow the resource manager to afterwards restore the context of the first processing core (if needed).

At 536, the second processing core sends an in-band SOS command packet to the resource manager. The in-band SOS command packet may be a starting indicator, which may indicate a beginning of a command packet transmission (e.g., workload) from the second processing core to the resource manager.

The in-band SOS command packet may also indicate whether or when to switch any context associated with the second processing core stored in the memory (e.g., any previously stored context of the second processing core) into an active region. For example, the in-band SOS command packet may indicate that there is no context associated with the second processing core to be loaded (e.g., since there was no previous activity of the second processing core at the resource manager).

At 538, the resource manager determines that there is no context associated with the second processing core to be loaded (e.g., which may be determined based on the in-band SOS command packet). For example, the resource manager may determine that the request from the second processing core is a first request from the second processing core and there is no previous activity of the second processing core corresponding to the resource manager. This may suggest there that there is no previously stored context of the second processing core that has to be restored.

At 540, the second processing core sends the command packet transmission (e.g., which may be associated with its workload) to the resource manager. For example, the second processing core may process the workload based on the execution resources that are granted to the second processing core.

In some aspects, the second processing core packets and instructions may begin processing from the instQ buffer.

At 542, the second processing core is in a busy state. For example, the second processing core may have access to the execution resources and processes the workload based on the granted execution resources. For example, during the busy state of the second processing core, arbReq[1]=1 and arbGnt[1]=1.

Also, at this same time, the first processing core may have sent the request to the resource manager for further access to the execution resources, but the resource manager has not allocated or granted the execution resources to the first processing core. For example, arbReq[0]=1 and arbGnt[0]=0.

FIG. 5C depicts a flow diagram for managing granting of access to the execution resources to a previously active processing core.

As indicated at 544, in the illustrated example, the current state is arbReq[1]=1 (e.g., which means that the request from the second processing core is sent to the resource manager), arbGnt[1]=1 (e.g., which means that the execution resources are granted to the second processing core), arbReq[0]=1 (e.g., which means that the request for the execution resources from the first processing core is sent to the resource manager), and arbGnt[0]=0 (e.g., which means that the execution resources are not granted to the first processing core).

At 546, the resource manager waits for a next or a subsequent timeslot to process the request from the first processing core. For example, the resource manager may wait until time allocated to the second processing core for access to the execution resources is finished to process the request from the first processing core.

At 548, the resource manager arbitrates for a next thread, after the time allocated to the second processing core for access to the execution resources is finished. For example, the resource manager may determine that the second processing core has lost access to the execution resources, after the time allocated to the second processing core for access to the execution resources is finished.

At 550, the resource manager sends an indication to the second processing core that the second processing core has lost access to the execution resources (e.g., after the second processing core time window for access to the execution resources has elapsed, the second processing core loses the grant to the execution resource). For example, the indication may indicate that arbGnt[1]=0 (e.g., which means that the execution resources are not granted to the second processing core).

At 552, the second processing core sends an in-band EOS command packet to the resource manager. The in-band EOS command packet may be an ending indicator, which may indicate an end of the command packet transmission from the second processing core to the resource manager. For example, the second processing core may determine to stop sending data and/or traffic to the resource manager and may send the in-band EOS command packet to the resource manager, once its time window for access to the execution resources has elapsed.

At 554, the resource manager sends an indication to grant access to the execution resources to the first processing core for a certain time slot, in response to the received request from the first processing core. For example, arbGnt[0]=1 (e.g., which means that the execution resources are granted to the first processing core).

The resource manager may grant access to the execution resources to the first processing core only after the resource manager receives the in-band EOS command packet from the second processing core.

At 556, the resource manager stores a current context of the second processing core (e.g., after the second processing core time window for access to the execution resources has elapsed) in the memory associated with the resource manager.

At 558, the resource manager updates the table storing the information associated with the different processing cores. For example, the resource manager may store the context associated with the second processing core in the table. This may allow the resource manager to afterwards restore the context of the second processing core (if needed).

At 560, the first processing core sends an in-band SOS command packet to the resource manager. The in-band SOS command packet may be a starting indicator, which may indicate a beginning of a command packet transmission (e.g., workload) from the first processing core.

The in-band SOS command packet may also indicate whether or when to switch any context associated with the first processing core stored in the memory (e.g., any previously stored context of the first processing core) into an active region. For example, the in-band SOS command packet may indicate that there is context associated with the first processing core to be loaded (e.g., since there was some previous activity of the first processing core at the resource manager).

At 562, the resource manager may restore a previously stored context of the first processing core from the table.

At 564, the first processing core (e.g., after its context has been restored) sends the command packet transmission (e.g., which may be associated with its workload) to the resource manager. For example, the first processing core may process the workload based on the execution resources that have been granted to the first processing core.

In some aspects, the first processing core may send the command packet transmission to the resource manager, after sending the in-band SOS command packet to the resource manager. In such cases, the command packet transmission may be stored in the instQ buffer until a restore sequence completes.

In certain aspects, to reduce an arbitration waiting time of a processing core for latency critical tasks (e.g., interrupt handlers), the processing core may qualify its arbitration request for access to the execution resources to the resource manager with a hi/low priority flag. A high priority flag may cause a low priority thread associated with some processing core to be switched out immediately, so a high priority request of another processing core for access to the execution resources can be served/processed soon by the resource manager.

In certain aspects, one or more schemes may be used by the processing core to determine whether its arbitration request should be treated as timing-critical. For example, a default priority for the arbitration request from the processing core is low. If the processing core takes an exception, its arbitration request priority goes to high until its sequence is complete. If during a high priority window the processing core needs to send instructions to the resource manager while not arbitrated, the processing core raises a high priority arbitration request. When the resource manager receives a high priority arbitration request, the resource manager may prioritize the high priority arbitration request over all other low-priority arbitration requests and threads. If a low priority thread is executing in the resource manager and the high priority arbitration request is asserted by another processing core, the low priority thread is context switched out immediately to make room for a high priority thread.

In some aspects, the resource manager may support fewer contexts than a number of processing cores of a processor system, with context switching between all processing cores. To enable this feature, an arbitration interface may be used, as well as a context save and restore mechanism. A reduced set of load and store instructions may be supported for out-of-context execution through the resource manager.

In some aspects, the processing core raises a request to indicate that the processing core has a workload for the resource manager to execute. The resource manager may raise a grant of resources for the processing core once the resource manager arbitrates and selects the processing core for processing. The processing core may lower its request if the processing core has completed its workload. The request may not be deasserted if the grant of the resources has not been received. This ensures that there is no race condition between the processing core removing its request and the resource manager sending the grant of the resources. The resource manager may lower the grant of the resources when the execution timeslot expires and another processing core wins arbitration for the execution resources.

### Example Method for Managing Common Execution Resources Between Multiple Processing Cores

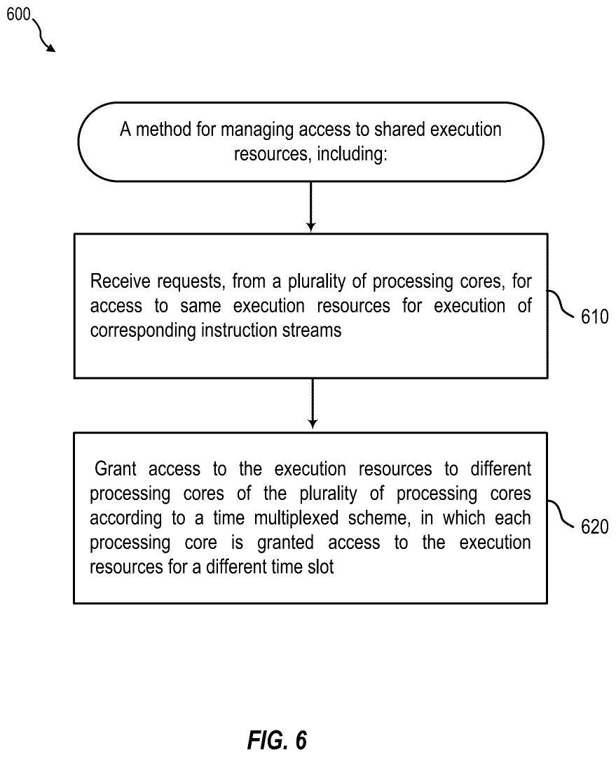

FIG. 6 depicts a method 600 for managing access to shared execution resources. The method 600 may be performed at a resource manager. The resource manager may include a memory including instructions and one or more processors configured to execute the instructions and cause the resource manager to perform the method 600.

The method 600 begins at 610 with receiving requests from a plurality of processing cores for access to same execution resources for execution of corresponding instruction streams.

The method 600 at 620 includes granting access to the execution resources to different processing cores of the plurality of processing cores according to a time multiplexed scheme, in which each processing core is granted access to the execution resources for a different time slot.

In certain aspects, the method 600 further includes storing a state of each processing core of the plurality of processing cores that has been granted access to the execution resources in a table at an end of a time duration for which the execution resources are granted to the each processing core.

In certain aspects, the method 600 further includes determining whether a state of a processing core of the plurality of processing cores that is being granted access to the execution resources has been previously stored in the table.

In certain aspects, the method 600 further includes restoring a previously stored state of the processing core, when the state of the processing core that is being granted access to the execution resources has been previously stored in the table.

In certain aspects, the access to the execution resources to the different processing cores for different time slots is granted based on an order of receipt of the requests from the different processing cores.

In certain aspects, the access to the execution resources to the different processing cores for different time slots is granted based at least on previous resource grant information associated with the different processing cores.

In certain aspects, the access to the execution resources to the different processing cores for different time slots is granted based on priority information associated with the requests from the different processing cores.

In certain aspects, the method 600 further includes grouping the requests in two groups including a first group and a second group. The first group includes a set of priority requests and the second group includes a set of non-priority requests.

In certain aspects, the method 600 further includes processing the set of priority requests prior to the set of non-priority requests.

In certain aspects, the method 600 further includes receiving a first request for the access to the execution resources from a first processing core of the plurality of processing cores at a first time point and a second request for the access to the execution resources from a second processing core of the plurality of processing cores at a second time point; and granting the access to the execution resources to the first processing core based on the first request at the first time point for a first time slot and to the second processing core based on the second request at the second time point for a second time slot. The second time point is after the first time point, and a duration of the first time slot is same as or different from a duration of the second time slot.

In certain aspects, the method 600 further includes receiving a first request for the access to the execution resources from a first processing core of the plurality of processing cores; determining that the execution resources are available and have not been allocated to any other processing core of the plurality of processing cores; and granting the access to the execution resources to the first processing core at a first time point for a first time slot.

In certain aspects, the method 600 further includes receiving an indication from the first processing core that no state of the first processing core has to be restored.

In certain aspects, the method 600 further includes receiving a second request for the access to the execution resources from a second processing core of the plurality of processing cores; determining the execution resources are currently allocated to the first processing core for the first time slot; and granting the access to the execution resources to the second processing core at a second time point for a second time slot, the second time point is after a duration of the first time slot. The duration of the first time slot may be same as or different from a duration of the second time slot.

In certain aspects, the method 600 further includes saving a state of the first processing core at an end of the first time slot in a table.

In certain aspects, the method 600 further includes receiving an indication from the second processing core that no state of the second processing core has to be restored.

In certain aspects, the method 600 further includes receiving a third request for the access to the execution resources from the first processing core; determining the execution resources are currently allocated to the second processing core for the second time slot; and granting the access to the execution resources to the first processing core at a third time point for a third time slot, the third time point is after a duration of the second time slot. The duration of the second time slot may be same as or different from a duration of the third time slot.

In certain aspects, the method 600 further includes saving a state of the second processing core at an end of the second time slot.

In certain aspects, the method 600 further includes receiving an indication from the first processing core that a previously stored state of the first processing core has to be restored, and restoring the previously stored state of the first processing core from the table.

Note that FIG. 6 is just one example of a method, and other methods including fewer, additional, or alternative steps are possible consistent with this disclosure.

### Example Clauses

Implementation examples are described in the following numbered clauses:
Clause 1: A method for managing access to shared execution resources, comprising: receiving requests, from a plurality of processing cores, for access to same execution resources for execution of corresponding instruction streams; and granting access to the execution resources to different processing cores of the plurality of processing cores according to a time multiplexed scheme, in which each processing core is granted access to the execution resources for a different time slot.
Clause 2: The method of clause 1, further comprising storing a state of each processing core of the plurality of processing cores that has been granted access to the execution resources in a table at an end of a time duration for which the execution resources are granted to the each processing core.
Clause 3: The method of clause 2, further comprising determining whether a state of a processing core of the plurality of processing cores that is being granted access to the execution resources has been previously stored in the table.
Clause 4: The method of clause 3, further comprising restoring a previously stored state of the processing core, when the state of the processing core that is being granted access to the execution resources has been previously stored in the table.
Clause 5: The method of any one of clauses 1-4, wherein the access to the execution resources to the different processing cores for different time slots is granted based on an order of receipt of the requests from the different processing cores.
Clause 6: The method of any one of clauses 1-5, wherein the access to the execution resources to the different processing cores for different time slots is granted based at least on previous resource grant information associated with the different processing cores.
Clause 7: The method of any one of clauses 1-6, wherein the access to the execution resources to the different processing cores for different time slots is granted based on priority information associated with the requests from the different processing cores.
Clause 8: The method of any one of clauses 1-7, further comprising grouping the requests in two groups comprising a first group and a second group, wherein the first group comprises a set of priority requests and the second group comprises a set of non-priority requests.
Clause 9: The method of clause 8, further comprising processing the set of priority requests prior to the set of non-priority requests.
Clause 10: The method of any one of clauses 1-9, wherein the receiving comprises receiving a first request for the access to the execution resources from a first processing core of the plurality of processing cores at a first time point and a second request for the access to the execution resources from a second processing core of the plurality of processing cores at a second time point; and the granting comprises granting the access to the execution resources to the first processing core based on the first request at the first time point for a first time slot and to the second processing core based on the second request at the second time point for a second time slot.
Clause 11: The method of clause 10, wherein the second time point is after the first time point; and a duration of the first time slot is same as or different from a duration of the second time slot.
Clause 12: The method of any one of clauses 1-11, wherein the receiving comprises receiving a first request for the access to the execution resources from a first processing core of the plurality of processing cores; determining that the execution resources are available and have not been allocated to any other processing core of the plurality of processing cores; and the granting comprises granting the access to the execution resources to the first processing core at a first time point for a first time slot.
Clause 13: The method of clause 12, further comprising receiving an indication from the first processing core that no state of the first processing core has to be restored.
Clause 14: The method of clause 12, wherein the receiving comprises receiving a second request for the access to the execution resources from a second processing core of the plurality of processing cores; determining the execution resources are currently allocated to the first processing core for the first time slot; and the granting comprises granting the access to the execution resources to the second processing core at a second time point for a second time slot, the second time point is after a duration of the first time slot.
Clause 15: The method of clause 14, further comprising saving a state of the first processing core at an end of the first time slot in a table.
Clause 16: The method of clause 14, further comprising receiving an indication from the second processing core that no state of the second processing core has to be restored.
Clause 17: The method of clause 14, wherein the duration of the first time slot is same as or different from a duration of the second time slot.
Clause 18: The method of clause 1, wherein the receiving comprises receiving a third request for the access to the execution resources from the first processing core; determining the execution resources are currently allocated to the second processing core for the second time slot; and the granting comprises granting the access to the execution resources to the first processing core at a third time point for a third time slot, the third time point is after a duration of the second time slot.
Clause 19: The method of clause 18, further comprising saving a state of the second processing core at an end of the second time slot.
Clause 20: The method of clause 18, further comprising receiving an indication from the first processing core that a previously stored state of the first processing core has to be restored; and restoring the previously stored state of the first processing core from the table.
Clause 21: The method of clause 18, wherein the duration of the second time slot is same as or different from a duration of the third time slot.
Clause 22: An apparatus, comprising: at least one memory comprising instructions; and one or more processors configured, individually or in any combination, to execute the instructions and cause the apparatus to perform a method in accordance with any one of Clauses 1-21.
Clause 23: An apparatus, comprising means for performing a method in accordance with any one of Clauses 1-21.
Clause 24: A non-transitory computer-readable medium comprising executable instructions that, when executed by one or more processors of an apparatus, cause the apparatus to perform a method in accordance with any one of Clauses 1-21.
Clause 25: A computer program product embodied on a computer-readable storage medium comprising code for performing a method in accordance with any one of Clauses 1-21.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for managing access to shared execution resources, comprising:
receiving requests, from a plurality of processing cores, for access to same execution resources for execution of corresponding instruction streams; and
granting access to the execution resources to different processing cores of the plurality of processing cores according to a time multiplexed scheme, in which each processing core is granted access to the execution resources for a different time slot.

2. The method of claim 1, further comprising storing a state of each processing core of the plurality of processing cores that has been granted access to the execution resources in a table at an end of a time duration for which the execution resources are granted to the each processing core.

3. The method of claim 2, further comprising:
determining whether a state of a processing core of the plurality of processing cores that is being granted access to the execution resources has been previously stored in the table; and
restoring a previously stored state of the processing core, when the state of the processing core that is being granted access to the execution resources has been previously stored in the table.

4. The method of claim 1, wherein the access to the execution resources to the different processing cores for different time slots is granted based on an order of receipt of the requests from the different processing cores.

5. The method of claim 1, wherein the access to the execution resources to the different processing cores for different time slots is granted based at least on previous resource grant information associated with the different processing cores.

6. The method of claim 1, wherein the access to the execution resources to the different processing cores for different time slots is granted based on priority information associated with the requests from the different processing cores.

7. The method of claim 1, further comprising:
grouping the requests in two groups comprising a first group and a second group, wherein the first group comprises a set of priority requests and the second group comprises a set of non-priority requests; and
processing the set of priority requests prior to the set of non-priority requests.

8. The method of claim 1, wherein:
the receiving comprises receiving a first request for the access to the execution resources from a first processing core of the plurality of processing cores at a first time point and a second request for the access to the execution resources from a second processing core of the plurality of processing cores at a second time point;
the granting comprises granting the access to the execution resources to the first processing core based on the first request at the first time point for a first time slot and to the second processing core based on the second request at the second time point for a second time slot;
the second time point is after the first time point; and
a duration of the first time slot is same as or different from a duration of the second time slot.

9. The method of claim 1, wherein:
the receiving comprises receiving a first request for the access to the execution resources from a first processing core of the plurality of processing cores;
determining that the execution resources are available and have not been allocated to any other processing core of the plurality of processing cores; and
the granting comprises granting the access to the execution resources to the first processing core at a first time point for a first time slot.

10. The method of claim 9, further comprising receiving an indication from the first processing core that no state of the first processing core has to be restored.

11. The method of claim 9, wherein:
the receiving comprises receiving a second request for the access to the execution resources from a second processing core of the plurality of processing cores;
determining the execution resources are currently allocated to the first processing core for the first time slot; and
the granting comprises granting the access to the execution resources to the second processing core at a second time point for a second time slot, the second time point is after a duration of the first time slot.

12. The method of claim 11, further comprising saving a state of the first processing core at an end of the first time slot in a table.

13. The method of claim 11, further comprising receiving an indication from the second processing core that no state of the second processing core has to be restored.

14. The method of claim 11, wherein the duration of the first time slot is same as or different from a duration of the second time slot.

15. The method of claim 12, wherein:
the receiving comprises receiving a third request for the access to the execution resources from the first processing core;
determining the execution resources are currently allocated to the second processing core for the second time slot; and
the granting comprises granting the access to the execution resources to the first processing core at a third time point for a third time slot, the third time point is after a duration of the second time slot.

16. The method of claim 15, further comprising saving a state of the second processing core at an end of the second time slot.

17. The method of claim 15, further comprising:
receiving an indication from the first processing core that a previously stored state of the first processing core has to be restored; and
restoring the previously stored state of the first processing core from the table.

18. The method of claim 15, wherein the duration of the second time slot is same as or different from a duration of the third time slot.

19. An apparatus for managing access to shared execution resources, comprising:
a memory comprising instructions; and
one or more processors, individually or collectively, configured to execute the instructions and cause the apparatus to:
receive requests, from a plurality of processing cores, for access to same execution resources for execution of corresponding instruction streams; and
grant access to the execution resources to different processing cores of the plurality of processing cores according to a time multiplexed scheme, in which each processing core is granted access to the execution resources for a different time slot.

20. A non-transitory computer-readable medium comprising instructions that, when executed by one or more processors, cause the one or more processors to perform a method, comprising:
receiving requests, from a plurality of processing cores, for access to same execution resources for execution of corresponding instruction streams; and
granting access to the execution resources to different processing cores of the plurality of processing cores according to a time multiplexed scheme, in which each processing core is granted access to the execution resources for a different time slot.
